(19) United States
(12) Patent Application Publication
(10) Pub. No.: US 2012/0046937 A1
(43) Pub. Date: Feb. 23, 2012

(54) SEMANTIC CLASSIFICATION OF VARIABLE DATA CAMPAIGN INFORMATION

(75) Inventors: Kirk J. Ocke, Ontario, NY (US); Dale Ellen Gaucas, Penfield, NY (US); Michael David Shepherd, Ontario, NY (US); Barry Glynn Gombert, Rochester, NY (US)

(73) Assignee: XEROX CORPORATION, Norwalk, CT (US)

(21) Appl. No.: 12/857,997

(22) Filed: Aug. 17, 2010

(51) Int. Cl. G06F 17/27

(52) U.S. Cl. 704/9

(57) ABSTRACT

A method and system for semantically classifying variable data campaign information. The method and system include loading, by a processing device, a variable data campaign from a computer readable storage medium operably connected to the processing device; extracting, by the processing device, variable data from the campaign; semantically classifying, by the processing device, the variable data to produce semantically classified variable data; building, by the processing device, a variable data campaign model based upon the semantically classified variable data; and storing, by the processing device, the variable data campaign model in the computer readable storage medium.

### RELATED APPLICATIONS

This application is related to U.S. patent application Ser. No. ______ (Attorney Docket No. 20091182-US-NP/121782.28901), filed Aug. 17, 2010, the contents of which are hereby incorporated by reference.

### Not Applicable

### BACKGROUND

The present disclosure relates to methods and systems for semantically classifying variable data. In some embodiments, the present disclosure relates to methods and systems for semantically classifying variable data for a large number of data campaigns.

Many websites and interactive software programs offer digital content libraries from which individual images, document templates, and/or graphics may be purchased by a user for use in creating one or more pieces of media for a data campaign.

In typical digital marketplaces, the user can use a keyword search to identify individual content. However, variable content and other digital media previously organized into variable data campaigns is difficult to search as the variable content related data fields are often hidden in various templates and other organizational structures within the variable data campaign. As a result of the organization of the campaign, the variable content is not easily classified, and thus, not easily searched. This can result in lost revenue for the digital marketplace because the digital marketplace might sell only a piece of the variable content to a customer instead of an entire variable data campaign as the user could also rely on other resources to produce a variable content campaign based upon the variable content obtained from the digital marketplace.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In one general respect, the embodiments disclose a method of semantically classifying variable data campaign information. The method includes loading, by a processing device, a variable data campaign from a computer readable storage medium operably connected to the processing device; extracting, by the processing device, variable data from the campaign; semantically classifying, by the processing device, the variable data to produce semantically classified variable data; building, by the processing device, a variable data campaign model based upon the semantically classified variable data; and storing, by the processing device, the variable data campaign model in the computer readable storage medium.

In another general respect, the embodiments disclose a system for semantically classifying variable data campaign information. The system includes a processing device and a computer readable storage medium in communication with the processing device. The computer readable medium includes one or more programming instructions for loading, by the processing device, a variable data campaign from the computer readable storage medium operably connected to the processing device; extracting, by the processing device, variable data from the campaign; semantically classifying, by the processing device, the variable data to produce semantically classified variable data; building, by the processing device, a variable data campaign model based upon the semantically classified variable data; and storing, by the processing device, the variable data campaign model in the computer readable storage medium.

In another general respect, the embodiments disclose a method of semantically classifying variable data campaign information includes loading, by a processing device, a variable data campaign from a computer readable memory operably connected to the processing device; extracting, by the processing device, variable data from the campaign, wherein the variable data comprises variable data fields and any related values and attributes; semantically classifying, by the processing device, the variable data according to at least one classification technique such that each identified variable data field is mapped to at least one semantic element; generating, by the processing device, a variable data campaign model based upon the identified variable data and the mapped semantic elements; and storing, by the processing device, the variable data campaign model in the computer readable medium.

### BRIEF DESCRIPTION OF THE DRAWINGS

FIG. 1 illustrates a flow diagram of an exemplary process for semantically classifying a campaign having variable data according to an embodiment;

FIG. 2 illustrates a flow diagram of an exemplary process for extracting variable data from a campaign according to an embodiment;

FIG. 3 illustrates a flow diagram of an exemplary process for semantically classifying variable data from a campaign according to an embodiment;

FIG. 4 illustrates an exemplary variable data campaign model according to an embodiment; and

FIG. 5 illustrates various embodiments of a computing device for implementing various methods and processes described herein.

### DETAILED DESCRIPTION

For purposes of the discussion below, a “campaign” refers to set of related media documents having variable data content and intended for one or more recipients.

A “media document” or “document” refers to a printed document or an electronic document such as a web page or email message.

“Variable data content” or “variable data” refers to content within the campaign that may differ between one document and another such as text and images.

A “variable data field” is a data field that may include data loaded or drawn from another source. For example, data contained in a spreadsheet column may be associated with one or more variable data fields.

A “variable data content model” refers to a representation of variable data content stored on a computer readable medium in a specific format. For example, a variable data content model may be stored as a linked list, a hierarchal tree, or the like.

“Semantically classifying” refers to a process of assigning a received datum to at least one of a plurality of predetermined semantic classes based upon one or more heuristics.

The present disclosure provides a system and method for semantically classifying variable data campaign information, organized in particular variable fields, such that semantically meaningful information is available for use in searching for and retrieving campaigns. The semantic classification may be accomplished by applying various classification heuristics and techniques to various campaign related information such as variable data field names, variable data field types (e.g., text or image fields), data source values, meta-data and content contained in any images, as well as other related information. Additional meaningful concepts may be extracted from the data campaigns such as cross-media campaign information as well as campaign names. Any information extracted relating to the campaign may be coalesced into a variable data campaign model that may be searched using conventional search techniques.

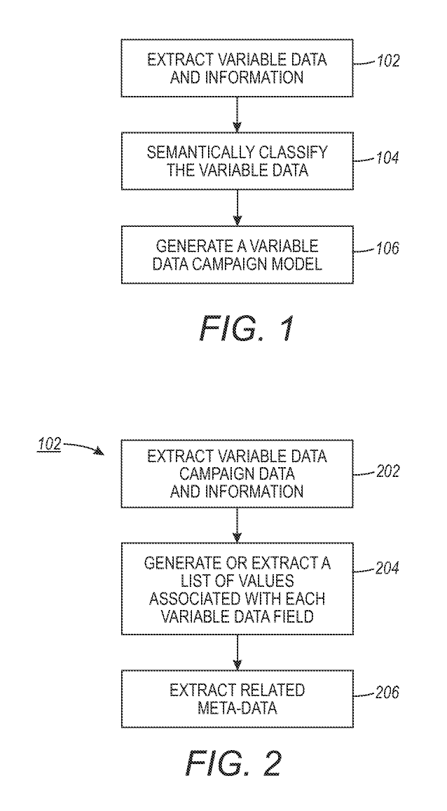

FIG. 1 illustrates a flow diagram of an exemplary process for semantically classifying a variable data campaign. Variable data and related information are extracted 102 from the variable data campaign. Extracting 102 variable data may include extracting variable data campaign data, identifying and/or extracting a list of sources for the variable data, and extracting meta-data related to any sources for the variable data. The extraction 102 of the variable data and information is discussed in greater detail in reference to FIG. 2 below.

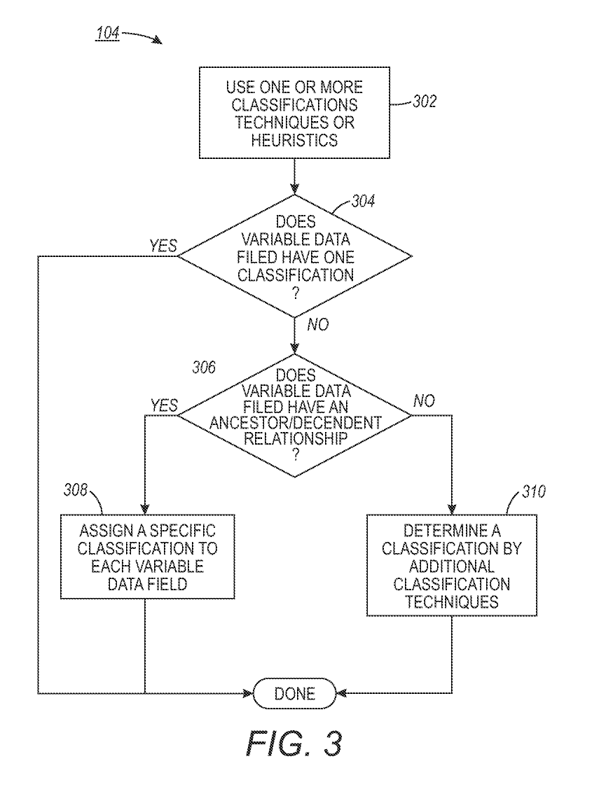

The extracted variable data may be semantically classified 104. Semantically classifying 104 the variable data may include using a number of heuristic classification techniques to organize and classify the variable data. The semantic classification 104 of the variable data and related information is discussed in greater detail in reference to FIG. 3 below.

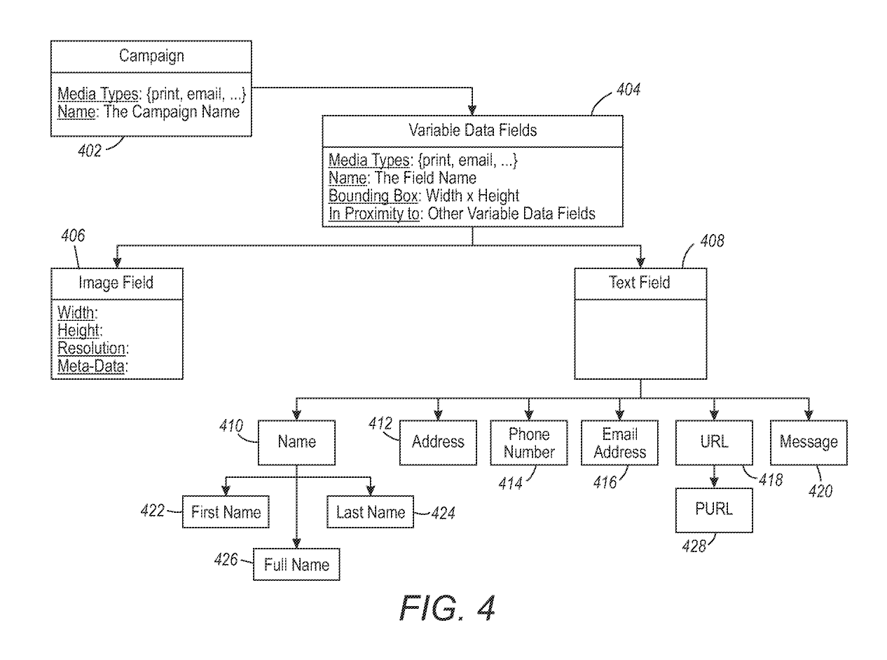

After the semantic classification 104, a variable data campaign model may be generated 106. The model may represent all the variable data, related information, and any other knowledge generated from the extraction 102 and classification 104 of the variable data. An exemplary variable data campaign model is discussed in greater detail in reference to FIG. 4 below.

FIG. 2 illustrates an expanded view of an exemplary process used to extract 102 variable data and related information as discussed above. The extraction 102 may include extracting 202 variable data campaign data and related information. The variable data campaign data and related information extraction 202 may include various individual steps. Any variable data fields and any information related to the variable data fields may be extracted. For example, the type of data field (e.g., text, image, graphic, etc.) may be extracted. Also, any names of the variable data fields, any data source expressions that may map the variable data field to a specific data source, and any rules for constructing the data field may be extracted 202. Additional information may be extracted 202 such as a data source (or data sources) used by the variable data campaign. Data sources may include spread sheets, databases, linked lists, or other common data structures. Meta-data associated with images may be extracted 202, as well as specific variable data campaign information, such as the variable data campaign name and whether the variable data campaign is a cross-media campaign.

Based upon the extracted 202 information, a list of values associated with each variable data field may be generated 204 or extracted from the data sources. Several exemplary methods may be used to generate 204 the list. An application programming interface (API) may be included with the variable data campaign system that implements the generation 204 functionality. Each variable data field may be associated with a simple expression that is extracted from the data source. For example, a variable data field may refer to a specific column or row in a spread sheet, in which case a list of values may be read from the spread sheet. Alternatively, the variable data field may refer to a rule for building a list of values from multiple data sources by using logic specified in the rule. In this example, the rule may be interpreted and a list of values generated by performing a process such as the one discussed in FIG. 1.

Additionally, during the extraction 102, related meta-data may be extracted 206. For example, if a variable data field refers to a specific column in a spread sheet having a designation (e.g., “addresses”, “telephone numbers”), the designation may be extracted 206 as related meta-data.

FIG. 3 illustrates a flow diagram of an exemplary process used to semantically classify 104 variable data and related information as discussed above in reference to FIG. 1. The classification 104 may include using 302 one or more classification techniques or heuristics to classify each individual variable data field as a specific semantic element. Various classification techniques may be used, though it should be noted only a few are identified and discussed herein. Each variable data field type (e.g., text, image, graphic) may be mapped to a specific semantic element type. For example, a variable data field containing text may be mapped to a text field semantic element while a variable data field containing an image may be mapped to an image field semantic element. This particular heuristic may provide a complete mapping of all variable data fields in a variable data campaign as each variable data field is mapped to at least one generic semantic element.

Another classification technique may be to infer which semantic element a particular variable data field is to be mapped to based upon the name of the variable data field. For example, if a variable data field is named “First Name,” it may be inferred that this variable data field is mapped to a text field semantic element. However, this classification technique may be unreliable if arbitrary names have been used in naming variable data fields.

Another classification technique may be to use a list of values or attributes associated with the variable data field to determine its classification. For example, the values or attributes may follow a predefined pattern. Email addresses, uniform resource locators (URLs) and permanent URLs (PURLs) may all follow a defined pattern. Alternatively, the values or attributes may be compared to data sources having a priori known semantic classifications. For example, if a list of values or attributes is compared to a listing of U.S. Census data representing common first names, and a high percentage of matched occurs, it may be inferred the list of values represents first names. Many publicly available data resources may be used to compare variable data fields using this technique.

Yet another classification technique may be to refer back to a data source for the variable data field for any identifying characteristics. For example, if a variable data field refers back to a specific column in a database, the name of that column may be used to classify the variable data field. However, this suffers from the problem identified above in that arbitrary names may have been used when the database was created.

It should be noted that additional known classification techniques and heuristics may be used such as referring to any meta-data contained in an image. The techniques listed above are provided merely by way of example.

After the initial classification techniques or heuristics are applied to the variable data field, a determination 304 may be made determining if the variable data field has exactly one classification. If the determination 304 shows the variable data field has one classification, the classification 104 may complete. However, if it is determined 304 the variable data field has more than one classification, each variable data field may be analyzed and a determination 306 may be made as to whether a classification may be determined for the variable data field based upon an ancestor/descendent relationship. To determine 306 an ancestor/descendent relationship, the source of the data for the variable data field may be analyzed. For example, if a variable data field refers to a specific column in a database, the contents of that column may be examined. One or more heuristics may be performed on the contents, and the results compared. For example, if analysis of the contents of a database column returns the classifications “name,” “text,” and “first name,” an ancestor/descendent relationship of “text→name→first name” may be determined based upon previously defined ontologies. After the ancestor/descendent relationship is determined, additional heuristics may be run to further classify the specific variable data field. If an ancestor/descendent relationship is determined 306, the variable data field may be assigned 308 a specific classification designation or name based upon the ancestor/descendent relationship and the classification process is complete.

Conversely, analysis of the content of the database column may not return an ancestor/descendent relationship. For example, the analysis may return “name,” “first name,” “address.” If a classification is not determined 306 for a variable data field based upon an ancestor/descendent relationship, a classification designation or name may be determined 310 via additional classification techniques such as fuzzy-classification, or a classification technique where the most commonly returned classification is used. Alternatively, a classification technique such as those discussed above may be assigned as a default classification to use to determine 310 the classification of all variable data fields determined 306 to not have an ancestor/descendent relationship.

FIG. 4 illustrates an exemplary variable data campaign model as built 106 from any extracted 102 and semantically classified 104 variable data campaign data. A variable campaign data model may be a data structure storing an organized representation of the variable data contained in a variable data campaign data, organized according to the semantic classification of the variable data campaign data. The variable data campaign model as shown in FIG. 4 is shown by way of example only, and may be extended to contain as many semantically classified elements as are identified in a variable data campaign. As shown in FIG. 4, the variable data campaign model may be constructed as a hierarchal model similar to a tree-like data structure. Each level further down the tree may be interpreted as being contained in the level directly above. For example, the top level includes element campaign 402. The element campaign 402 may include various attributes such as media types (i.e., which media types are included in the campaign such as print, email), and the name of the campaign. The classification 402 may be classified into an element variable data field 404. It should be noted that only one variable data field 404 is shown for convenience; however, a plurality of variable data fields 404 may be included.

The variable data field 404 may include various attributes such as one or more media types the variable data field may be used on (e.g., print, email), the name of the variable data field, the bounding box or size of the variable data field shown in this example as width by height, and whether the variable data field is in proximity to any other variable data fields. It should be noted these attributes as shown by way of example only and may be altered depending on the available information related to the variable data field 404.

In this example, the variable data field 404 may be further classified into two types of elements, an image field 406 and a text field 408. The image field 406 may include various attributes such as width, height, resolution, and any related meta-data. Though not shown in FIG. 4, the text field 408 may include various attributes such as font, font size, and other related attributes as well.

The text field 408 may be further classified into various types of text elements such as name 410, address 412, phone number 414, email address 416, URL 418, and a message 420. Each type of text may be further classified into one or more specific classifications. For example, the name 410 may be further classified as either first name 422, last name 424, or full name 426. Similarly, the URL 418 may be further classified as a PURL 428.

Once a set of campaigns have been classified as variable campaign data models as shown in FIG. 4, the variable data contained in the campaigns may be searched by a user using standard searching techniques such as converting the semantically classified data fields in a variable data campaign model to keywords, and allowing users or customers to search the keywords. For example, an online digital content marketplace may implement standard searching techniques to allow a customer to not only search images, graphics, templates and other variable data content, but also use the classification system discussed herein to allow the customer to search entire campaigns. For example, if the customer wishes to search for content related to pictures of dogs, not only will the marketplace return search results including various images of dogs for sale, but the marketplace may also return entire campaigns of various media types including and related to dogs. Additionally, the digital content marketplace may solicit customer feedback through web-form based input, or through email or other text responses. These responses may then be reviewed by a marketplace administrator, and based upon the responses, the semantic classification system as discussed above may be modified and improved by providing additional features related to the naming and classification of the variable data content.

On exemplary implementation of the variable data campaign classification system as described above may be integrated with an online marketplace such as the XMPie marketplace. In a digital content marketplace such as the XMPie marketplace, large amount of data contained in variable data campaigns may be stored as relatively unsorted data. The variable data campaigns may be previously developed by previous users, website content developers, graphical artists, as well as anyone else who has created one or more electronic documents incorporating variable data. A new user to the marketplace may wish to purchase and distribute a variable data campaign. An existing campaign may satisfy any requirements the new user may have, however, as the variable data within the campaign is unsorted, the new user may not be able to identify the variable data campaign. Thus, the user may need to create an entirely new variable data campaign. This may cost the new user both time and money that would be ultimately saved if the previously created variable data campaigns were sorted and classified.

Using the variable data campaign classification system and techniques as discussed above, an online marketplace may quickly and efficiently organize all previously created variable data campaigns for easy searching. Instead of creating a new campaign, the new user may simply search for specific criteria, identify a previously created campaign that matches the new user's requirements, provide sources for any required variable data contained in the identified campaign (e.g., a database listing names, addresses and email addresses), and then purchase any media contained in the campaign. The user may be given the option to print, email, or physically mail and resulting media.

Additionally, meaningful concepts beyond merely the information associated with the variable data fields may also be extracted. For example, meta-data describing the media contained within the campaign may be extracted, sorted, and organized for searching. Similarly, user input related to an individual campaign may be extracted for each campaign and similarly sorted for future searching.

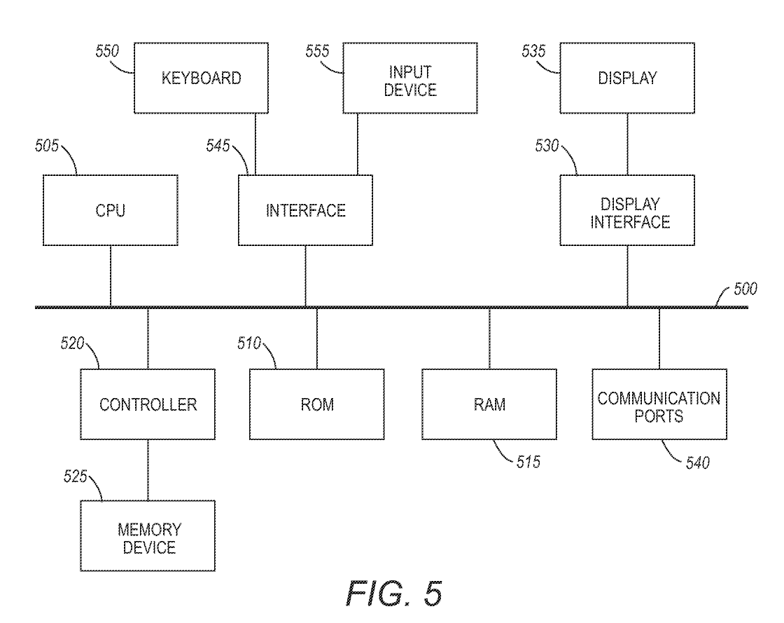

The variable data campaign classification system, user feedback interface, and various software modules described above may be presented on a display based on software modules including computer-readable instructions that are stored on a computer readable medium such as a hard drive, disk, memory card, USB drive, or other recording medium. FIG. 5 depicts a block diagram of exemplary internal hardware that may be used to contain or implement program instructions such as the process steps discussed above in reference to FIGS. 1, 2 and 3, as well as a suitable storage medium to store the variable campaign data model discussed above in reference to FIG. 4. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an exemplary processing device, computing device or processor as such terms are used within this disclosure. Read only memory (ROM) 510 and random access memory (RAM) 515 constitute exemplary memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any feedback information, common files for storing groups of feedback information, or one or more databases for storing the feedback information.

Program instructions, software or interactive modules for providing the digital marketplace and performing analysis on any received feedback may be stored in the ROM 510 and/or the RAM 515. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 530 may permit information from the bus 500 to be displayed on the display 535 in audio, visual, graphic or alphanumeric format. Communication with external devices may occur using various communication ports 540. An exemplary communication port 540 may be attached to a communications network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of semantically classifying variable data campaign information comprising:
loading, by a processing device, a variable data campaign from a computer readable storage medium operably connected to the processing device;
extracting, by the processing device, variable data from the campaign;
semantically classifying, by the processing device, the variable data to produce semantically classified variable data;
building, by the processing device, a variable data campaign model based upon the semantically classified variable data; and
storing, by the processing device, the variable data campaign model in the computer readable storage medium.

2. The method of claim 1, wherein the extracting variable data from the campaign comprises:
extracting variable data campaign data, wherein the variable data campaign data includes a plurality of variable data field;
determining a data source for each of the variable data fields;
extracting a list of values associated with each variable data field based upon the determined data source; and
extracting meta-data related to the variable data field.

3. The method of claim 2, wherein the determined data source includes at least one of a database, a spread sheet, and a linked list.

4. The method of claim 1, wherein the semantically classifying the variable data comprises applying one or more classification techniques to the variable data to determine one or more semantic classifications for each variable data field and whether the one or more semantic classifications of each first variable data field has an ancestor/descendent relationship.

5. The method of claim 4, wherein the one or more classification techniques includes at least one of:
mapping a variable data field to one or more semantic elements based upon the variable data field type associated with the variable data field;
inferring one or more semantic elements to which a variable data field is mapped to based upon the name of the variable data field;
using a list of values associated with a variable data field to determine a semantic element to map the variable data field to; and
determining a name based upon a data source of one of a variable data field.

6. The method of claim 4, wherein the determining whether the one or more semantic classifications of a variable data field in the variable data has an ancestor/descendent relationship comprises:
determining a source of content for the variable data field;
applying at least one heuristic to the content;
determining whether the result of the at least one heuristic indicates an ancestor/descendent relationship for the variable data field; and
determining at least one specific classification for the variable data field based upon the result.

7. The method of claim 6, wherein the at least one specific classification includes at least one of text or image.

8. The method of claim 1, wherein the variable data campaign model comprises a hierarchal organization of one or more variable data fields extracted from the variable data campaign.

9. A system for semantically classifying variable data campaign information comprising:
a processing device; and
a computer readable storage medium in communication with the processing device,
wherein the computer readable medium comprises one or more programming instructions for:
loading, by the processing device, a variable data campaign from the computer readable storage medium operably connected to the processing device,
extracting, by the processing device, variable data from the campaign,
semantically classifying, by the processing device, the variable data to produce semantically classified variable data,
building, by the processing device, a variable data campaign model based upon the semantically classified variable data, and
storing, by the processing device, the variable data campaign model in the computer readable storage medium.

10. The system of claim 9, wherein the one or more programming instructions for extracting any variable data from the campaign comprise one or more programming instructions for:
extracting variable data campaign data, wherein the variable data campaign data includes a plurality of variable data field;
determining a data source for each of the variable data fields;
extracting a list of values associated with each variable data field based upon the determined data source; and
extracting meta-data related to the variable data field.

11. The system of claim 10, wherein the determined data source includes at least one of a database, a spread sheet, and a linked list.

12. The system of claim 9, wherein the one or more programming instructions for semantically classifying the variable data comprises applying one or more classification techniques to the variable data to determine one or more semantic classifications for each variable data field and whether the one or more semantic classifications of each variable data field has an ancestor/descendent relationship.

13. The system of claim 12, wherein the one or more programming instructions for applying one or more classification techniques comprise one or more programming instructions for:
mapping a variable data field to one or more semantic elements based upon the variable data field type associated with the variable data field;
inferring one or more semantic elements to which a variable data field is mapped to based upon the name of the variable data field;
using a list of values associated with a variable data field to determine a semantic element to map the variable data field to; and
determining a name based upon a data source of one of a variable data field.

14. The system of claim 12, wherein one or more programming instructions for determining whether the one or more semantic classifications of a variable data field has an ancestor/descendent relationship comprises:
determining a source of content for the variable data field;
applying at least one heuristic to the content;
determining whether the result of the at least one heuristic indicates an ancestor/descendent relationship for the variable data field; and
determining at least one specific classification for the variable data field based upon the result.

15. The system of claim 14, wherein the at least one specific classification includes at least one of text or image.

16. The system of claim 9, wherein the variable data campaign model comprises a hierarchal organization of one or more data fields extracted from the variable data campaign.

17. A method of semantically classifying variable data campaign information comprising:
loading, by a processing device, a variable data campaign from a computer readable memory operably connected to the processing device;
extracting, by the processing device, variable data from the campaign, wherein the variable data comprises variable data fields and any related values and attributes;
semantically classifying, by the processing device, the variable data according to at least one classification technique such that each identified variable data field is mapped to at least one semantic element;
generating, by the processing device, a variable data campaign model based upon the identified variable data and the mapped semantic elements; and
storing, by the processing device, the variable data campaign model in the computer readable medium.

18. The method of claim 17, wherein the extracting variable data from the campaign comprises:
extracting variable data campaign data, wherein the variable data campaign data includes a plurality of variable data field;
determining a data source for each of the variable data fields;
extracting a list of values associated with each variable data field based upon the determined data source; and
extracting meta-data related to the variable data field.

19. The method of claim 18, wherein the determined data source includes at least one of a database, a spread sheet, and a linked list.

20. The method of claim 17, wherein the variable data campaign model comprises a hierarchal organization of one or more data fields extracted from the variable data campaign.
